(19) United States
(12) Patent Application Publication
(10) Pub. No.: US 2025/0328966 A1
(43) Pub. Date: Oct. 23, 2025

(54) SYSTEMS AND METHODS FOR CROSS PLATFORM SOCIAL MEDIA PERFORMANCE SCORING

(71) Applicant: Pollen LLC, North Charleston, SC (US)

(72) Inventors: Carl K. Rust, III, Charleston, SC (US); Michael Gasser, Charleston, SC (US); William Ragans, Seabook, SC (US); Nathan Scott Herr, Saint Johns, FL (US); Matthew Colin Fitz-Henry, Ponte Vedra, FL (US)

(21) Appl. No.: 19/185,117

(22) Filed: Apr. 21, 2025

Related U.S. Application Data
(60) Provisional application No. 63/636,511, filed on Apr. 19, 2024.

(51) Int. Cl. G06Q 50/00

(52) U.S. Cl. CPC G06Q 50/01

(57) ABSTRACT

Systems, methods, and computing devices for generating and presenting cross-platform performance scores for social media content are disclosed herein. According to an aspect, a system includes a social media content engagement manager configured to receive data indicative of user engagement with social media content presented via one or more social media platforms. The social media content engagement manager is also configured to determine measures of user engagement with the social media content based on the received data. Further, the social media content engagement manager is configured to apply the determined measures to a performance model for generating a performance score of the social media content. The is also configured to present the performance score to a user via a user interface.

### CROSS-REFERENCE TO RELATED APPLICATIONS

This application claims priority to U.S. Provisional Patent Application No. 63/636,511, filed Apr. 19, 2024, the disclosure of which is incorporated herein by reference in its entirety.

### BACKGROUND

Social media platforms such as FACEBOOK® social media service, INSTAGRAM® social media service, LINKEDIN® social media service, X™ (formerly TWITTER®) social media service, TIKTOK® social media service, YOUTUBE® social media service, and others are integral to modern digital marketing strategies. These platforms offer organizations a range of publishing formats and audience targeting tools designed to generate visibility, engagement, and conversions. Content published on these platforms can take the form of text posts, images, videos, carousels, stories, shorts, and reels-each with its own engagement conventions and measurement standards.

Given their ubiquity, these platforms present a challenge when it comes to evaluating performance across multiple channels. Metrics are platform-specific, differ in how they are measured or named, and do not lend themselves to easy cross-comparison. For example, an engagement rate on one platform might include views in its denominator, whereas another might calculate engagement rate based on reach or impressions. This inconsistency makes it difficult for businesses and marketing teams to evaluate the holistic impact of their social content strategy.

Traditional approaches to performance evaluation require manual compilation of data from each platform, alignment of metrics into shared definitions, and subjective interpretation of what constitutes success. While some software solutions attempt to consolidate performance data, they often treat each metric in isolation, fail to normalize for platform-specific context, or lack meaningful scoring systems that reflect strategic importance and historical relevance.

In view of the foregoing, there is a need for improved systems for performance evaluation of social media services and for the presentation of this performance evaluation to users.

### SUMMARY OF THE DISCLOSURE

Disclosed herein are systems, methods, and computing devices for generating and presenting cross-platform performance scores for social media content. According to an aspect, a system includes a social media content engagement manager configured to receive data indicative of user engagement with social media content presented via one or more social media platforms. The social media content engagement manager is also configured to determine measures of user engagement with the social media content based on the received data. Further, the social media content engagement manager is configured to apply the determined measures to a performance model for generating a performance score of the social media content. The social media content engagement manager is also configured to present the performance score to a user via a user interface.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block diagram of an example system 100 for generating and presenting performance scores for social media content in accordance with embodiments of the present disclosure;

FIG. 2 is a flowchart of an example method for generating and presenting performance scores for social media content in accordance with embodiments of the present disclosure;

FIG. 3 is a flowchart of another example method for generating and presenting performance scores for social media content in accordance with embodiments of the present disclosure;

FIG. 4 is a depiction of engagement metrics, weight values, and other information regarding user engagement with a post of social media content in accordance with embodiments of the present disclosure; and

FIG. 5 depicts a screen display showing a performance score associated with a post of social media content on a social media platform in accordance with embodiments of the present disclosure.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-service (QoS) policies. The core layer can provide high-speed, highly redundant forwarding services to move packets between distribution layer devices in different regions of the network. The core layer typically includes multiple routers and switches.

The disclosed subject matter describes systems, methods, and computing devices for evaluating the effectiveness of social media content across platforms by calculating a normalized and standardized performance score. This score allows for the direct comparison of social content performance regardless of platform, content type, or metric definitions.

In accordance with embodiments, a method can include collecting engagement data from multiple platforms through direct integrations (e.g., APIs), third-party tools, or manual input. The system can identify which engagement signals are available for each piece of content and processes these using a proprietary normalization and weighting framework. The outcome is a cross-platform performance score that summarizes overall performance into a single numeric value.

The performance score calculation can include three primary phases: (1) ingestion and availability mapping of engagement metrics per platform and content type; (2) evaluation of engagement values relative to historically observed averages for the same account or brand; and (3) normalization and scaling of weighted results into a bounded performance score.

While each engagement signal—such as likes, comments, shares, reactions, impressions, views, reach, click-throughs, watch time, view completions, conversions, or subscriber change—contributes to the final score, the relative importance of these signals is internally defined. The model can employ an internally maintained framework that reflects observed engagement quality, user intent, and contribution to marketing outcomes.

In embodiments, the score can be platform-agnostic and context-aware. For example, a post's performance on TikTok is evaluated using metrics relevant to that environment, such as completion rate or average watch time, and then scaled against that account's historical averages on the same platform. In contrast, a post on the LINKEDIN® social media platform may prioritize metrics such as comments, shares, and click-throughs. In both cases, the system adapts evaluation logic to account for content type, user interaction modes, and platform-specific metric definitions.

The final output can be a numeric score, typically on a 0-5 scale, with a range adjustable in the future to account for expanded detail, that provides an at-a-glance assessment of how a specific post, video, reel, or story performed in the context of prior brand engagement history and platform expectations. This can allow for consistent benchmarking and performance optimization at both tactical (individual post) and strategic (campaign, brand, or channel) levels.

In embodiments, the system can include multiple modules implemented through software and operated via one or more computing devices, including web servers, cloud-based processing environments, user interfaces, and API connections to social media platforms.

In embodiments, the system workflow can proceed through the following stages:

Metric Availability Mapping: When a new piece of content is evaluated, the system first determines which engagement metrics are available for the given post. This step accounts for platform differences and content formats—for example, Reels vs. Posts vs. Stories—and maps available signals accordingly.

Weighted Value Computation: Each available metric is assigned a proprietary significance value based on internal modeling of its contribution to content success. The system computes a weighted metric value by multiplying the observed value of each metric against its internally defined multiplier. These multipliers reflect the system's understanding of each metric's typical business relevance.

Historical Benchmarking: For each metric, the system maintains account-level historical averages. The observed value for the current post is compared against its corresponding average to determine whether it over-or underperformed. This relative performance is used to adjust the raw weighted score. The social media content engagement manager 104 can include a historical benchmarking module configured to compare current engagement measures to account-specific historical averages.

Normalization and Scaling: To ensure cross-platform comparability, the system applies normalization logic that scales post-level scores into a consistent range. The scaling function accounts for data variability, expected engagement range, and proprietary controls for compression or amplification. The social media content engagement manager 104 can include a normalization module configured to normalize weighted engagement metrics into a bounded performance score range.

Aggregate Score Generation: The system aggregates normalized results from all available metrics and generates a single score per piece of content. Performance scores can be presented to users via a graphical user interface (GUI) within a larger analytics dashboard.

Interpretation, Comparison, and Insight: The performance score's primary utility lies in enabling users to compare high-scoring and low-scoring posts across time. By reviewing and contrasting the creative attributes, media formats, post timing, and messaging of successful posts against underperforming ones, users can derive insight into what types of content resonate best with their specific audience. This allows business owners and marketing teams to identify patterns—e.g., videos perform better than image posts on certain days of the week, or educational content drives higher engagement than promotional posts—and iteratively optimize content strategies.

Visualization and Strategic Learning: The interface includes chronological breakdowns, campaign views, and filtering by content format or platform. When paired with visual cues like badges or color-coded performance tiers, this allows users to distinguish which creative elements and publishing contexts yield consistently higher scores. These insights provide not only retrospective performance evaluation, but also forward-looking guidance for future content development.

Use Case Scenarios: Consider a small bakery using the platform to promote seasonal offerings. After publishing a reel on Instagram and a post on Facebook featuring new autumn pastries, the Pollen Score calculates performance using available engagement data. The Facebook post garners moderate reach and strong comment engagement, while the Instagram reel achieves a high completion rate but lower click-throughs. When compared against previous posts, the system identifies that posts featuring close-up product videos with a soft soundtrack perform better than text-heavy graphics. The bakery refines its visual style accordingly.

In another case, a local plumbing company promotes an educational TIKTOK® post explaining how to prevent winter pipe bursts. The content receives lower likes but higher-than-average shares and completions relative to historical averages. Although total impressions were modest, the performance score identifies it as a top-performing post due to its educational value and high engagement depth. By comparing this video to lower-scoring content—such as sales-only messages or short-format memes—the business discovers that useful, well-explained tips generate the most meaningful interactions.

Over time, both businesses can use the performance score not just as a performance indicator, but as a learning engine. The score helps them isolate and codify what content types, tones, calls-to-action, and even durations or posting times are most effective for their brand and audience.

As referred to herein, the term “social media platform” can refer generally to a digital service that enables its users to generate, share, and interact with social media content and/or connect with others online. Example social media platforms include, but are not limited to, FACEBOOK® social media service, INSTAGRAM® social media service, LINKEDIN® social media service, X™M (formerly TWITTER®) social media service, TIKTOK® social media service, YOUTUBE® social media service.

As referred to herein, the term “social media content” can refer generally to digital material generated and distributed on social media platforms. Example, social media content includes, but is not limited to, text posts, images, video, carousels, audio, stories, an interactive element, short, reels, a link, and the like. Texts, for example, can be posted, a part of a caption, a part of a thread. An image can be a photo, a meme, an infographic, or an illustration. Video content can be a short-form video (e.g., a TIKTOK® reel) or a long-form video (e.g., a YOUTUBE® vlog). Audio content can be a podcast, a voice clip, or a soundbite. An interactive element can be a poll, a quiz, or a live stream. A link can be an external URL to an article, product, or website.

Systems, computing devices, and methods disclosed herein may utilize data indicative of user engagement with social media content presented via one or more social media platforms. This data may be used to generate a performance score associated with social media platform users' engagement with posted social media content. For example, a representative of a company, such as an employee responsible for marketing, may post social media content to one or more social media platforms as part of a marketing campaign. The performance score for the post may indicate the effectiveness of the posted social media content and thus inform the person effective ways to post social media content for marketing.

Social media platform users may interact with posted social media content in any suitable manner that may be indicative of their level of engagement. Example interactions include, but are not limited to, likes, reactions, comments, shares, click-throughs, swipe-ups, completions, and a conversion action. These actions can be measured and subsequently used for indicating user engagement with the post. This data may include, but is not limited to, any suitable measure of user engagement with the social media content, a rate of user engagement with the social media content, a measure of reach of users with the social media content, a number of impressions with the social media content, likes, reactions, comments, shares, click-throughs, swipe-ups, completions, and a conversion action.

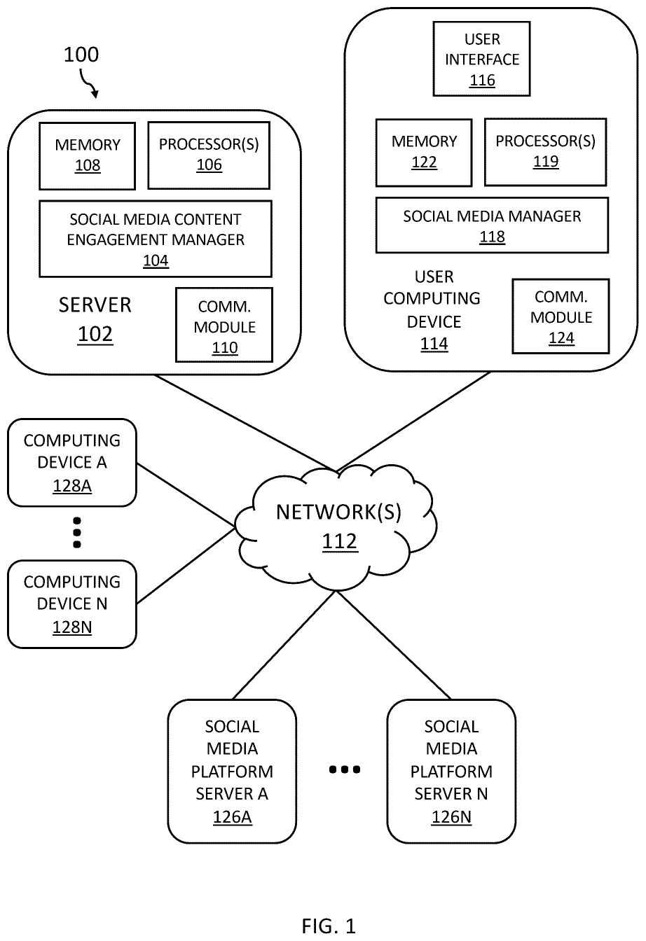

FIG. 1 illustrates a block diagram of an example system 100 for generating and presenting performance scores for social media content in accordance with embodiments of the present disclosure. Referring to FIG. 1, the system 100 includes a server 102 configured to receive data indicative of user engagement with social media content presented via one or more social media platforms. The server 102 is also configured to determine measures of user engagement with the social media content based on the received data. Further, the server 102 is configured to apply the determined measures to a performance model for generating a performance score of the social media content. The server 102 is also configured to present the performance score to a user via a user interface.

The server 102 can include a social media content engagement manager 104 for implementing the aforementioned functionalities of the server 102 and other functionalities. For example, the server 102 can include suitable hardware, software, and/or firmware for implementing the functionalities described herein. For example, the server 102 can include one or more processors 106 that implement instructions stored in memory 108 for implementing the functionalities.

The server 102 may include a communications module 110 configured to enable the server 102 to communicate with other computing devices. For example, the communications module 110 may be configured to communicate with other computing devices via one or more networks 112. Example networks include, but are not limited to, the internet, a cellular network, a local area network, and the like.

In embodiments, server 102 can include functionalities for assisting a user to manage a social media marketing account. For example, a user of computing device 114 may utilize a user interface 116 of the computing device 114 for engaging an application for social media marketing. The application may be a web application provided by the server 102 via the network(s) 112. By use of the application, a user of the computing device 114 can manage the posting of social media content for marketing or other purposes via one or more social media platforms. In addition, the application provided by the social media content engagement manager 104 can present data indicative of user engagement with the posted social media content. For example, the user interface 116 can present indicators of a measure of user engagement with posted social media content, a rate of user engagement with the social media content, a measure of reach of users with the social media content, a number of impressions with the social media content, likes, reactions, comments, shares, click-throughs, swipe-ups, completions, a conversion action, and the like. The user interface 116 can include one of a dashboard, a badge, color-coded tiers, or the like.

The computing device 114 can include a social media manager 118 for implementing the aforementioned functionalities of the computing device 114 and other functionalities. For example, the computing device 114 can include suitable hardware, software, and/or firmware for implementing the functionalities described herein. For example, the computing device 114 can include one or more processors 119 that implement instructions stored in memory 122 for implementing the functionalities.

The computing device 114 may include a communications module 124 configured to enable the computing device 114 to communicate with other computing devices. For example, the communications module 110 may be configured to communicate with other computing devices via network(s) 112.

The user of computing device 114 can have accounts with one or more social media platforms. Functionalities of the social media platforms may be implemented by social media platform servers 126A-126N (where “N” is variable to indicate a suitable number of servers). The user of computing device 114 may interact with the servers 126A-126N via network(s) 112. For example, the user may use the social media manager 118 for generating social media content and posting the social media content across one or more social media platforms enabled by the servers 126A-126N.

Other users may be presented with and view the social media content by use of computing devices 128A-128N. For example, a user of computing device 128A may via text, images, videos, or the like posted by the user of computing device 114. In this example, the text, images, or video can be posted and stored at server 126, and subsequently communicated to computing device 128A for presentation.

Continuing the aforementioned example, the user of computing device 128A can engage or interact with the posted social media content. For example, a user interface of the computing device 128A may display or otherwise present the social media content. The user can use the user interface of the computing device 128A to, for example, like the post or otherwise interact with the post. In this way, the engagement can demonstrate that the post was effective in capturing the attention of the user.

Servers 126A-126N may each maintain tracking data of users' engagement with the posted social media content of the user of computing device 114 or other users. The data may be stored in the servers 126A-126N. Server 102 may be communicatively connected to the servers 126A-126N for accessing the engagement data for determining various measures of users' engagement with posted social media content.

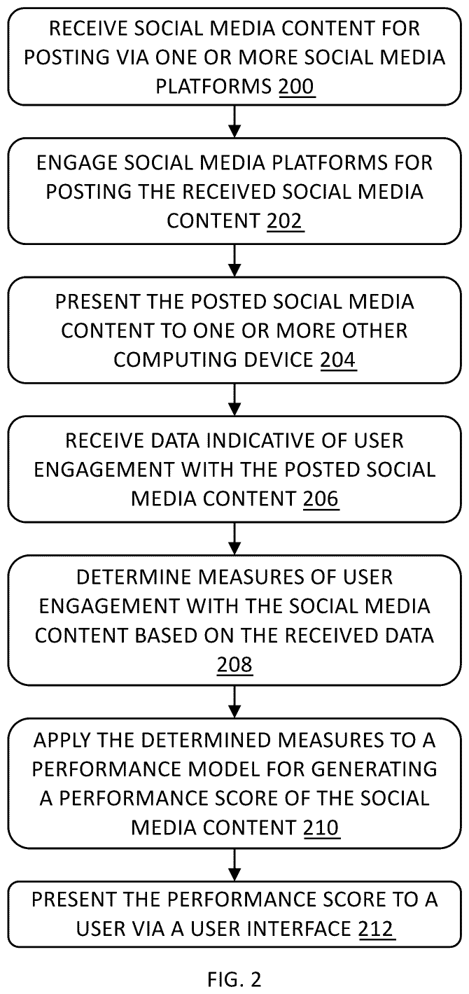

FIG. 2 illustrates a flowchart of an example method for generating and presenting performance scores for social media content in accordance with embodiments of the present disclosure. The method is described by example as being implemented by the server 102 shown in FIG. 1, but it should be understood that the method may be implemented by any other computing device or multiple computing devices.

Referring to FIG. 2, the method includes receiving 200 social media content for posting via one or more social media platforms. For example, the user at computing device 114 can interact with the user interface 116 to generate social media content (e.g., text, an image, and/or video) for posting to multiple social media platforms. The social media manager 118 of the computing device 118 can receive the generated social media content and communicate the generated social media content to server 102 via the network(s) 112. The social media content engagement manager 104 can receive the generated social media content. Further, the user at computing device 114 can specify which social media platforms to post the generated social media content. The user may also specify a schedule of time for posting the generated social media content. This information may also be communicated to the server 102 for use by social media content engagement manager 104.

The method of FIG. 2 includes engaging 202 social media platforms for posting the received social media content via one or more social media platforms. Continuing the aforementioned example, the social media content engagement manager 104 can communicate with one or more of servers 126A-126N for posting the social media content. In an example, the social media content engagement manager 104 may access stored credential information for the user of the computing device 114 for each of the social media platforms. Example credential information includes login and password information or a stored token. The social media content engagement manager 104 can access web applications of the social media platforms and use the credential information or token for accessing social media accounts of the user of the computing device 114 or delegated business accounts for which the user has been granted access and permissions for post on behalf of. The user of the computing device 114 may have previously provided such credential information when setting up an account with a social media management service implemented by the social media content engagement manager 104.

As an example of engagement social media platforms for posting social media content, after being approved for login, the social media content engagement manager 104 can control the communication of the social media content to each server 126A-126N for posting. In addition, the social media content engagement manager 104 can send information about a timing for posting the social media content on the respective social media platforms. Each server 126A-126N can receive and post the social media content to its respective platform and in accordance with a posting schedule if specified.

The method of FIG. 2 includes presenting 204 the posted social media content to one or more other computing devices. Continuing the aforementioned example, one or more of the computing devices 128A-128N may be utilized by respective users for accessing social media applications provided by 126A-126N. For example at computing device 128A, its user can access and view a social media webpage that presents the posted social media content.

The method of FIG. 2 includes receiving 206 data indicative of user engagement with the posted social media content presented via the social media platform(s). For example, the associated social media platform server can recognize that the posted social media content has been viewed, and subsequently record data indicative of this engagement. The social media platform server can also recognize other user engagement with the posted social media content, such as a “like”, a comment entered for the post, or a click-through. The social media platform server can also record this data that indicates this engagement with the posted social media content. The data and/or measures of user engagement with the posted social media content may be communicated by one or more of the servers 126A-126N to server 102, where the data and/or measures are stored in memory 108.

The method of FIG. 2 includes determining 208 measures of user engagement with the social media content based on the received data. Continuing the aforementioned example, the social media content engagement manager 104 can access the data of user engagement with the posted social media content stored in memory 108. Further, the social media content engagement manager 104 can determine measures of user engagement with the social media content based on the data. For example, amounts and timing of user engagement with the posted social media content for use with a performance model that, when used, can provide a performance score for the posted social media content. The performance model can include one or more variables and weights associated with the variables. The social media content engagement manager 104 can dynamically adjust the weights based on a learning algorithm.

The method of FIG. 2 includes applying 210 the determined measures to a performance model for generating a performance score of the social media content. Continuing the aforementioned example, the social media content engagement manager 104 can apply the measures of user engagement to the performance model for generating a performance score. For example, the social media content engagement manager 104 can apply the determined measures to variables of the performance model for generating the performance score of the social media content. In another example, the social media content engagement manager 104 can compare the determined measures as weighted by the performance model to corresponding historical averages for other posted social media content for a user account associated with the social media content.

The method of FIG. 2 includes presenting 212 the performance score to a user via a user interface. Continuing the aforementioned example, the performance score can be a number or other indicator of performance of the posted social media content for engaging users. The social media content engagement manager 104 can control the communication of the performance score to the computing device 114 of the user who posted the social media content so that the user can judge the effectiveness of the post for user engagement. As an example, the performance score can be displayed to the user by the user interface 116. The interface that displays the performance score may be a web application that functions as a dashboard for the user to control postings of social media content, information related to the postings, and performance scores determined for the postings in accordance with embodiments of the present disclosure.

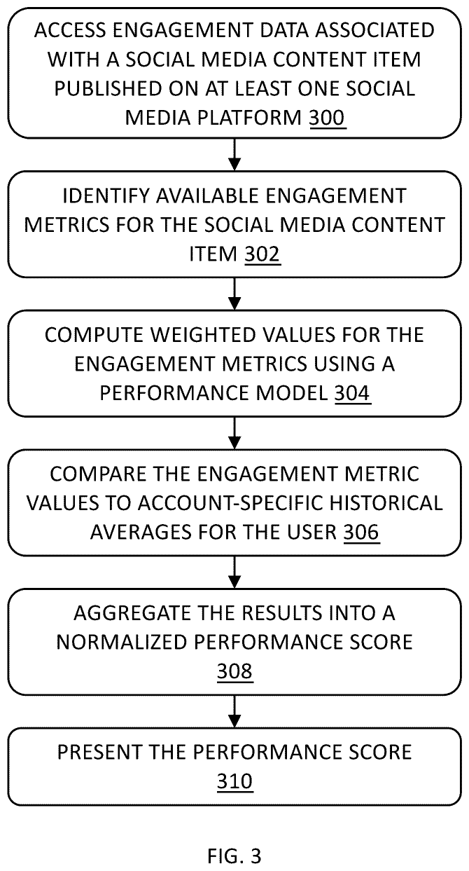

FIG. 3 illustrates a flowchart of another example method for generating and presenting performance scores for social media content in accordance with embodiments of the present disclosure. The method is described by example as being implemented by the server 102 shown in FIG. 1, but it should be understood that the method may be implemented by any other computing device or multiple computing devices.

Referring to FIG. 3, the method includes accessing 300 engagement data associated with a social media content item published on at least one social media platform. For example, the social media content engagement manager 104 can control interaction with one or more of the social media platform servers 126A-126N to access engagement data with a posted social media content item. For example, the item may be a video, image, or text posted to a social media account of the user of user computing device 114.

The method of FIG. 3 includes identifying 302 available engagement metrics for the social media content item. Continuing the aforementioned example, the social media content engagement manager 104 can engage with one or more of the social media platforms to identify any available engagement metrics with the social media content item. For example, the servers 126A-126N may make available engagement metrics for the posted social media content item, such as views or other interactivity or engagement. The engagement metrics may be accessed and retrieved by the social media content engagement manager 104. Example engagement metrics include, but are not limited to, comments, shares, likes, reactions, impressions, views, reach, click-throughs, swipe-ups, completions, conversion actions, and the like.

The method of FIG. 3 includes computing 304 weighted values for the engagement metrics using a performance model (or engagement importance model). Continuing the aforementioned example, the social media content engagement manager 104 can compute weighted values for the engagement metrics using a performance model.

The method of FIG. 3 includes comparing 306 the engagement metric values to account- specific historical averages for the user. Continuing the aforementioned example, the social media content engagement manager 104 can compare 306 the engagement metric values to account-specific historical averages for the user who posted the social media content item.

The method of FIG. 3 includes aggregating 308 the results into a normalized performance score. Continuing the aforementioned example, the social media content engagement manager 104 can aggregate 308 the results into a normalized performance score. As an example, the normalization process can scale scores based on historical variability and expected engagement distribution.

The method of FIG. 3 includes presenting 310 the performance score. Continuing the aforementioned example, the social media content engagement manager 104 can communicate the performance score to the user computing device 114 where it can be presented (e.g., displayed) in accordance with embodiments of the present disclosure. As an example, the performance score can be displayed within a dashboard or reporting interface. The score can indicate cross-platform performance by unifying data from different content formats and social platforms.

In embodiments, metric significance can be updated dynamically using artificial intelligence (AI)-driven inference models trained on historical engagement outcomes. The AI model can adjust the relative importance of engagement metrics over time based on content performance trends. The AI model can be account-specific and can adapt scoring logic based on prior user interactions across platforms. In an example, machine learning logic can identify emergent engagement behaviors and recommends adjustments to the scoring framework.

In embodiments, the social media content engagement manager 104 can include an artificial intelligence (AI)—machine learning (ML) adaptation module. This module can update metric-specific values based on ML analysis of historical engagement data.

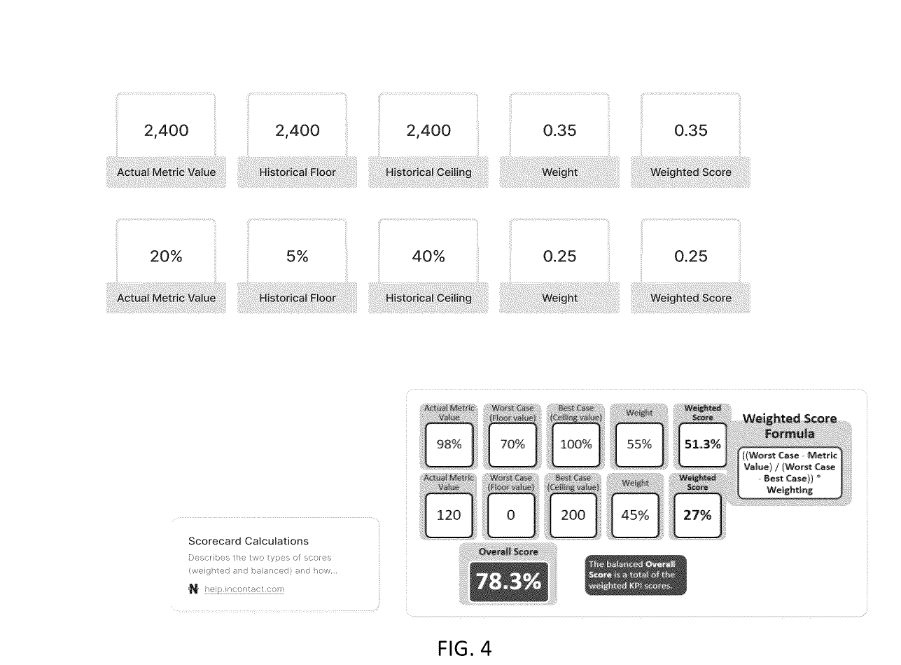

FIG. 4 illustrates a depiction of engagement metrics, weight values, and other information regarding user engagement with a post of social media content in accordance with embodiments of the present disclosure.

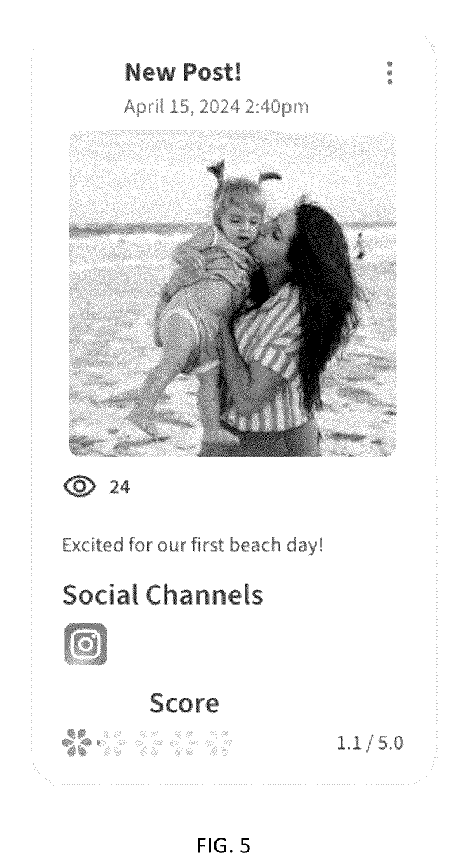

FIG. 5 depicts a screen display showing a performance score associated with a post of social media content on a social media platform in accordance with embodiments of the present disclosure. Referring to FIG. 5, the score in this example is 1.1 out of 5.0, with 5.0 being the highest possible score. Also, the score is visually depicted in the lower left of the display.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini-or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device and may be embodied in any suitable form and organized within any suitable type of data structure. The operational data may be collected as a single data set or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment but rather should be construed in breadth and scope in accordance with the appended claims.

1. A system comprising:
a social media content engagement manager configured to:
receive data indicative of user engagement with social media content presented via one or more social media platforms;
determine measures of user engagement with the social media content based on the received data;
apply the determined measures to a performance model for generating a performance score of the social media content; and
present the performance score to a user via a user interface.

2. The system of claim 1, wherein the social media content includes one of a text post, an image, a video, a carousel, a story, a short, audio, an interactive element, and a reel.

3. The system of claim 1, wherein the data indicative of user engagement includes one of a measure of user engagement with the social media content, a rate of user engagement with the social media content, a measure of reach of users with the social media content, a number of impressions with the social media content, likes, reactions, comments, shares, click-throughs, swipe-ups, completions, and a conversion action.

4. The system of claim 1, further comprising a computing device including the social media content engagement manager.

5. The system of claim 1, further comprising a computing device including the social media content engagement manager, and
wherein the computing device is configured to receive the data indicative of user engagement from a plurality of other computing devices.

6. The system of claim 1, wherein the social media content engagement manager is configured to receive the data indicative of user engagement from a plurality of computing devices that implement social media functionalities of a plurality of different platform types.

7. The system of claim 1, wherein the data is generated at a plurality of computing devices that implement social media functionalities of a plurality of different platform types.

8. The system of claim 1, wherein the performance model includes a plurality of variables and weights associated with the variables, and
wherein the social media content engagement manager is configured to apply the determined measures to variables of the performance model for generating the performance score of the social media content.

9. The system of claim 8, wherein the social media content engagement manager is configured to dynamically adjust the weights based on a learning algorithm.

10. The system of claim 1, wherein the social media content engagement manager is configured to compare the determined measures as weighted by the performance model to corresponding historical averages for other posted social media content for a user account associated with the social media content.

11. The system of claim 1, further comprising a user interface configured to display the performance score.

12. The system of claim 1, wherein the user interface includes one of a dashboard, a badge, and color-coded tiers.

13. A method comprising:
receiving data indicative of user engagement with social media content presented via one or more social media platforms;
determining measures of user engagement with the social media content based on the received data;
applying the determined measures to a performance model for generating a performance score of the social media content; and
presenting the performance score to a user via a user interface.

14. The method of claim 11, wherein the social media content includes one of a text post, an image, a video, a carousel, a story, a short, audio, an interactive element, and a reel.

15. The method of claim 11, wherein the data indicative of user engagement includes one of a measure of user engagement with the social media content, a rate of user engagement with the social media content, a measure of reach of users with the social media content, a number of impressions with the social media content, likes, reactions, comments, shares, click-throughs, swipe-ups, completions, and a conversion action.

16. The method of claim 11, wherein the steps of receiving, determining, applying, and presenting are implement at a computing device.

17. The method of claim 11, further comprising receiving the data indicative of user engagement from a plurality of computing devices.

18. The method of claim 11, further comprising receiving the data indicative of user engagement from a plurality of computing devices that implement social media functionalities of a plurality of different platform types.

19. The method of claim 11, further comprising generating the data at a plurality of computing devices that implement social media functionalities of a plurality of different platform types.

20. The method of claim 11, wherein the performance model includes a plurality of variables and weights associated with the variables, and
wherein the method further comprises applying the determined measures to variables of the performance model for generating the performance score of the social media content.

21. The method of claim 20, further comprising dynamically adjusting the weights based on a learning algorithm.

22. The method of claim 11, further comprising comparing the determined measures as weighted by the performance model to corresponding historical averages for other posted social media content for a user account associated with the social media content.

23. The method of claim 11, further comprising using a user interface to display the performance score.

24. The method of claim 23, wherein the user interface includes one of a dashboard, a badge, and color-coded tiers.

25. A computer program product comprising a computer readable storage medium having program instructions embodied therewith, the program instructions executable by a computing device to cause the computing device to:
receive, by the computing device, measures of user engagement with the social media content based on the received data;
determine, by the computing device, artificial intelligence functionalities to generate additional content based on the content associated with the user; and
apply, by the computing device, the determined measures to a performance model for generating a performance score of the social media content; and
present, by the computing device, the performance score to a user via a user interface.
